(19) United States
(12) Patent Application Publication
(10) Pub. No.: US 2006/0146657 A1
(43) Pub. Date: Jul. 6, 2006

(54) Headrest mounted disc player with display

(76) Inventor: Claudio R. Laraia, Mohegan Lake, NY (US)

Correspondence Address: RICHARD C. CALDERWOOD, 2775 NW 126TH AVE, PORTLAND, OR, 97229-8381, US

(21) Appl. No.: 11/030,840

(22) Filed: Jan. 5, 2005

(51) Int. Cl. G11B 21/08

(52) U.S. Cl. 369/30.01

(57) ABSTRACT

A video display and media player assembly for coupling to a vehicle seat back or headrest. The video display and the media player can be one integral component, or they can be two distinct components and can be coupled together. A shroud holds the video display and the media player, and includes a recess or a slot for providing access to a disc slot or a disc tray of the media player. Optionally, an adaptor mates with the shroud and custom fits the assembly to a particular seat back or headrest.

### BACKGROUND OF THE INVENTION

1 Technical Field of the Invention

This invention relates generally to mounting in-car video displays to seat backs or headrests, and more specifically to an improved mounting shroud for holding a display which includes an integrated video disc player.

2. Background Art

FIG. 1 and detail view IA illustrate a typical automobile seat 10 having a seat bottom 12, a seat back 14, and a headrest 16 which is coupled to the seat back by a pair of rods 18.

An in-car video assembly 20 is mounted onto or into the headrest for viewing by passengers in rear seating row(s) behind this seat. The video display assembly includes a display 22 such as a TFT-LCD screen or the like, which is mounted in a shroud 24. The shroud is coupled to an adaptor 26 which is customized for this particular headrest.

The display 22 includes only the video display unit itself. A remote video source (not shown) such as an in-dash DVD player feeds a video signal to the display unit via a cable (not shown) which is routed through the seat and up through or adjacent to one of the rods.

### BRIEF DESCRIPTION OF THE DRAWINGS

FIG. 1 shows an automobile seat having a headrest-mounted video display.

FIG. 2 shows an improved headrest-mounted video display and disc player assembly according to one embodiment of this invention, including a shroud and an adaptor.

FIG. 3 shows an exploded view of the video display and disc player assembly.

FIG. 4 shows a partial cross-section view of the video display and disc player assembly.

FIG. 5 shows a headrest-mounted video disc player and display assembly having a different embodiment of a shroud.

FIG. 6 shows a headrest-mounted video disc player and display assembly having another embodiment of a shroud.

FIG. 7 shows a headrest-mounted video disc player and display assembly in which the shroud is partially embedded into the headrest.

FIG. 8 shows a perspective front view of the shroud, with a partial cross-section.

FIG. 9 shows a perspective rear view of the shroud, with a partial cross-section.

FIG. 10 shows a perspective front view of the adaptor, with a partial cross-section.

FIG. 11 shows a perspective rear view of the adaptor, with a partial cross-section.

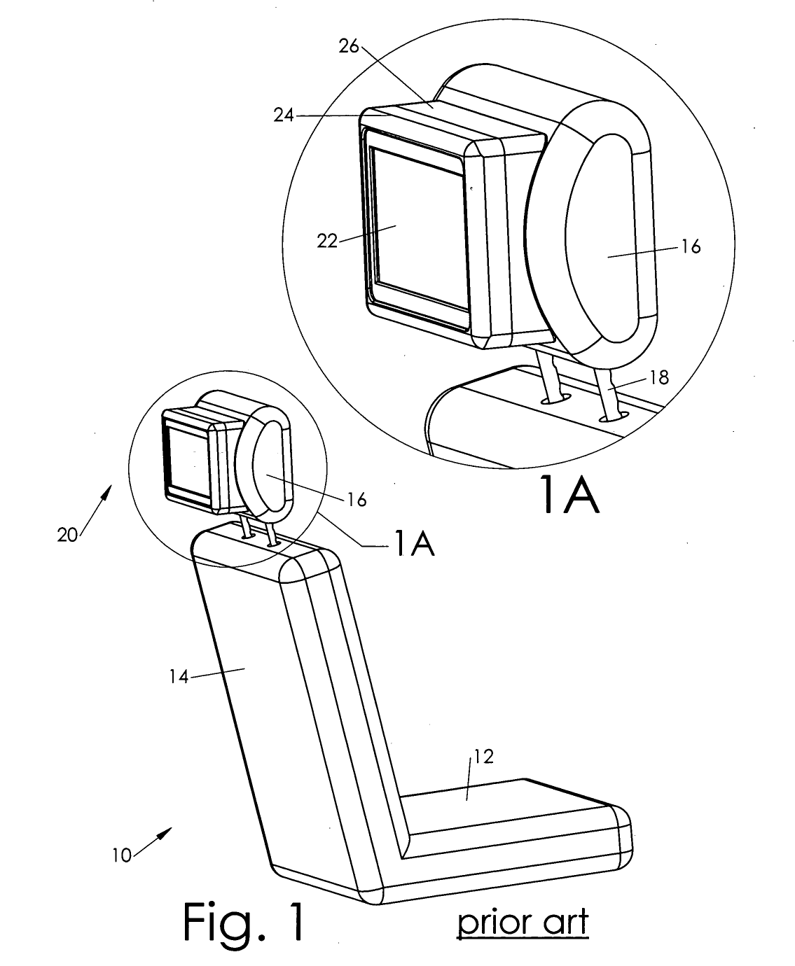

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

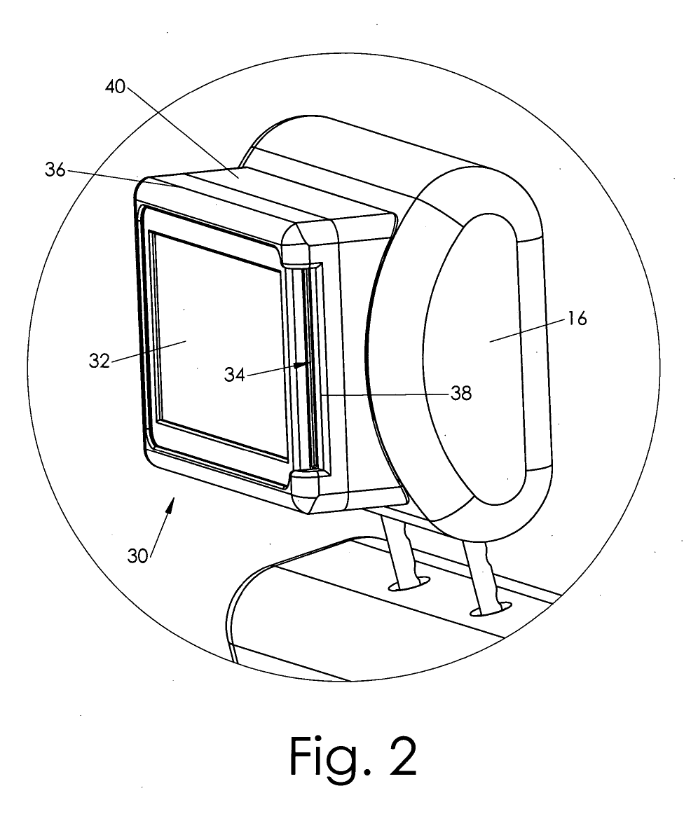

FIG. 2 illustrates a video display and disc player assembly 30 according to one embodiment of this invention, mounted to a headrest 16. The invention can also be practiced with seats which include an elongated seat back rather than a separate headrest.

The video unit includes a video display unit 22 and a video disc player which may be integrally manufactured as a single unit, or two separate units with the video display in front of the video disc player (wherein “in front of” means toward the viewer, rather than toward the front of the vehicle), hereinafter a “video unit” whether integral or assembled. The video disc player includes a slot 34 into which video discs such as, DVDs are inserted for playback.

The video unit is housed in a shroud 36, and the shroud is coupled to the headrest such as by an adaptor 40. In order to provide access to the slot, the shroud includes a recess 38 extending into the shroud in a direction perpendicular to the display screen sufficiently far to uncover the slot.

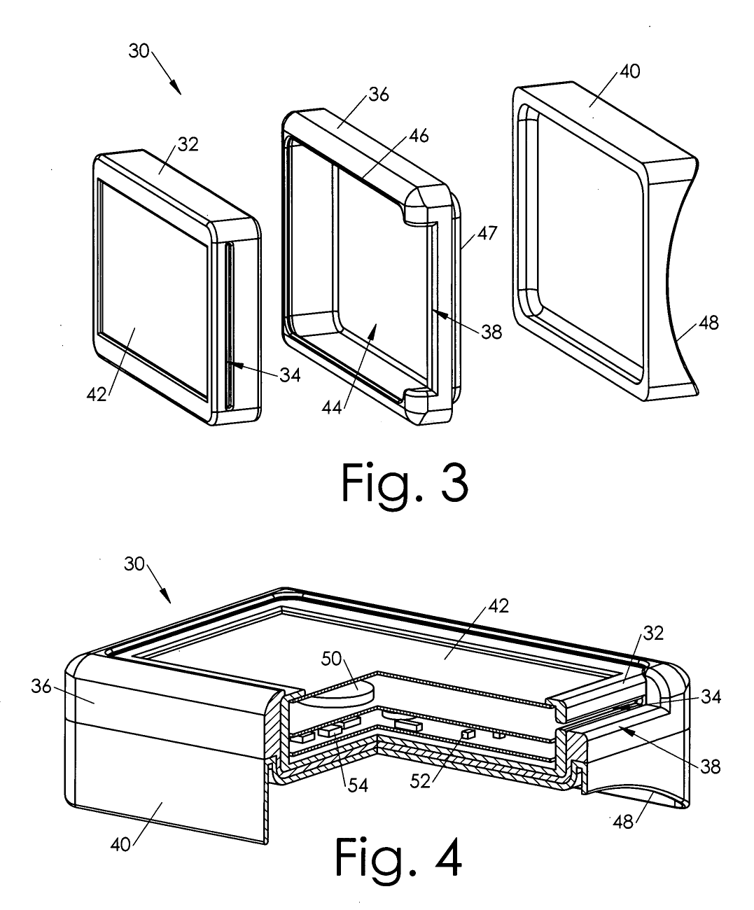

FIG. 3 illustrates the video display and disc player assembly 30 in an exploded view. The video unit 32 includes a video display screen 42 and a disc slot 34. The shroud 36 has a cavity 44 which is shaped and sized to house the video display and disc player assembly, and a lip 46 which extends slightly inward to retain the video unit. The shroud is sufficiently plastic that, during installation of the video unit, the shroud deforms enough to let the video unit pass into the cavity and beneath the lip. The shroud includes a cutaway or recess 38 configured to provide access to the disc slot. The shroud mates with an adaptor 40 which includes a surface 48 which is shaped (at the factory or by the installer) to mate with the headrest (not shown). The shroud includes a rear portion 47 which may be inserted into the adaptor, and which may be inserted inside the headrest.

FIG. 4 illustrates the video display and disc player assembly 30 in partial cross-sectioned view. The video unit 32 includes a video screen 42, behind which is a disc player. The disc player includes a slot 34 into which a video disc (not shown) can be inserted, and a disc reader 50 such as a laser pickup for reading data from the disc. The disc player further includes circuitry 52 for generating a video signal from that data, and circuitry 54 for driving that video signal to the display screen.

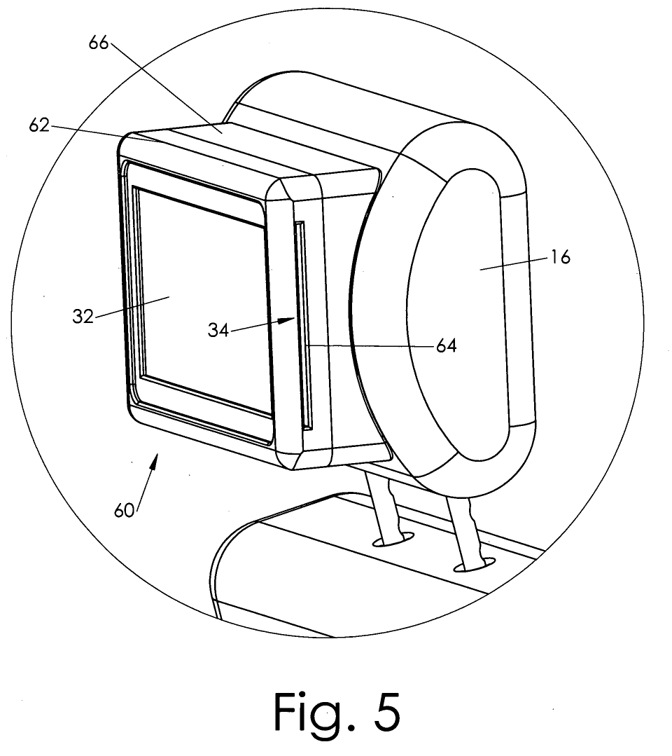

FIG. 5 illustrates another embodiment of a video display and disc player assembly 60 mounted to a headrest 16. A video unit 32 having a disc slot 34 is held in a shroud 62. The shroud includes a shroud slot 64 providing access to the disc slot. An adaptor 66 mates with the shroud and couples it to the headrest.

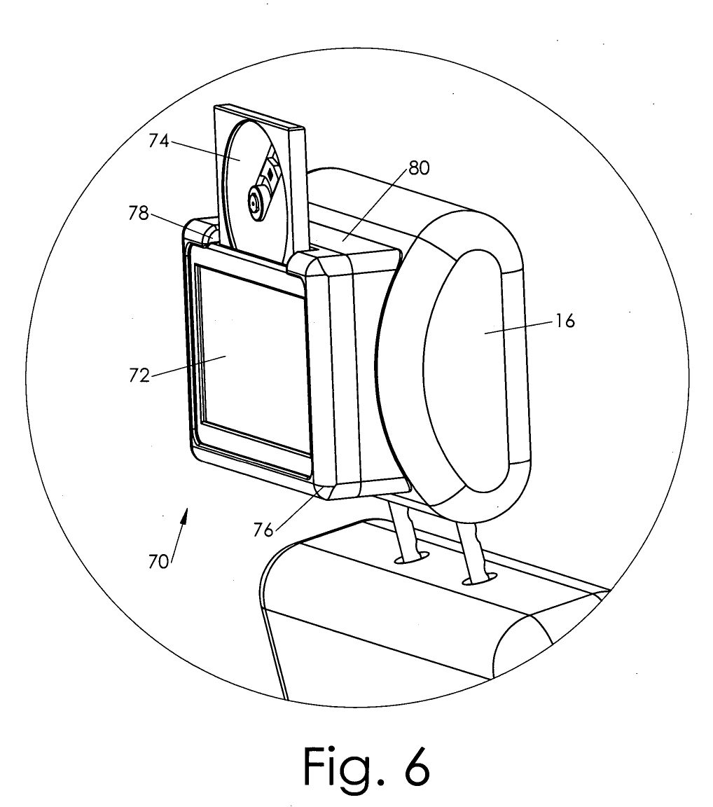

FIG. 6 illustrates another embodiment of a video display and disc player assembly 70 mounted to a headrest 16. A video unit 72 has a tray 74 rather than a disc slot, and is housed in a shroud 76 which includes a recess 78 of sufficient dimensions to permit unobstructed operation of the disc tray. An adaptor 80 mates with the shroud and couples it to the headrest.

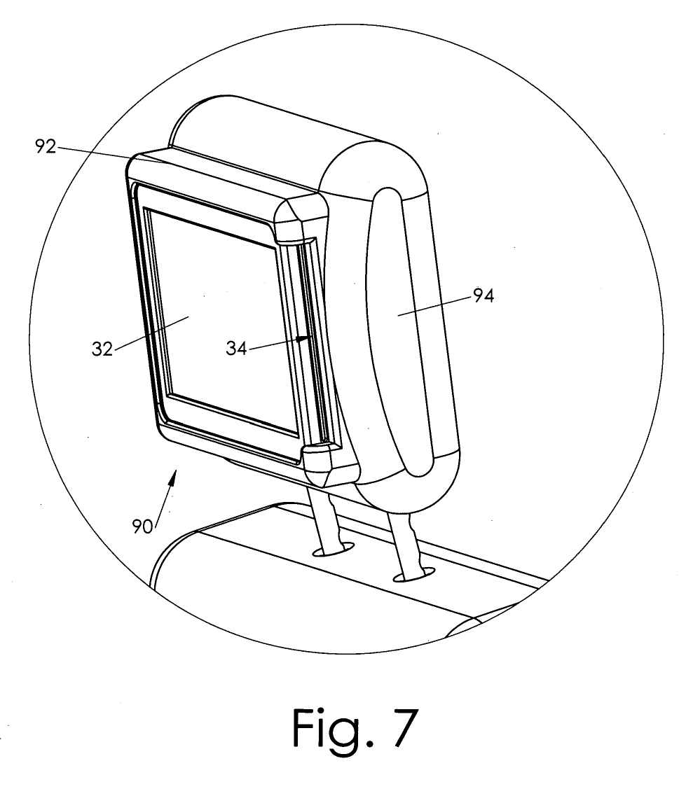

FIG. 7 illustrates another embodiment of a video display and disc player assembly 90 which, rather than merely being mated to the outer contours of the headrest 94, is cut in and recessed into the headrest. In some embodiments, the assembly is recessed sufficiently far that at least a portion of the display unit 32 is disposed inside the perimeter of the headrest. The assembly may be inserted into the headrest until the slot 34 only just barely remains exposed. In the embodiment shown, the shroud 92 mates the assembly directly to the headrest, without the need for any adaptor. Or, in other words, the adaptor is integral with the shroud.

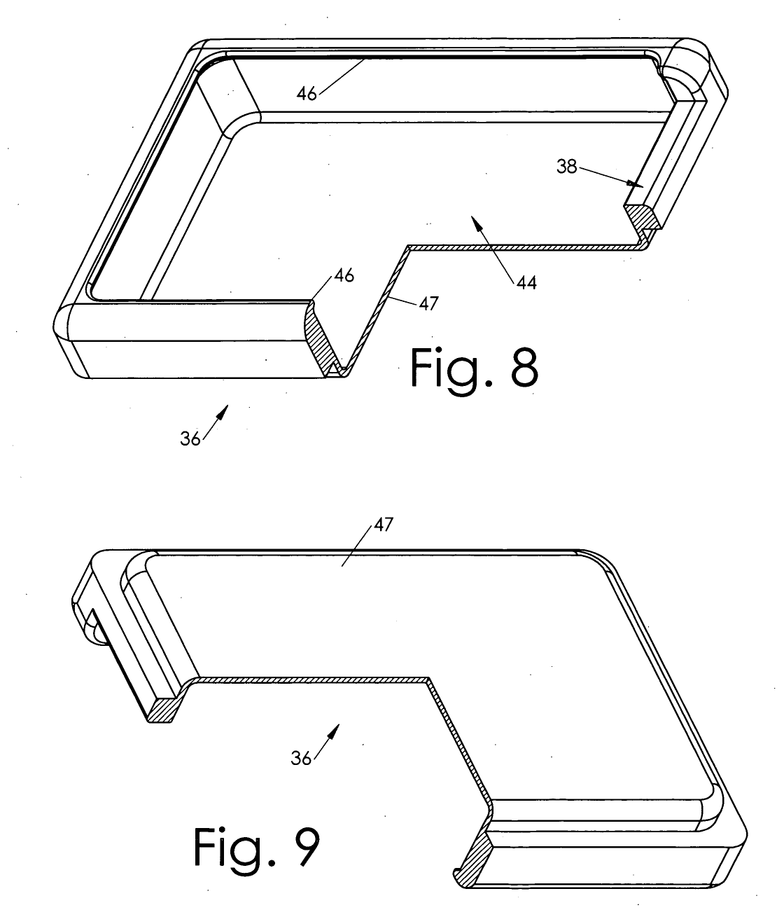

FIGS. 8 and 9 illustrate one embodiment of the shroud 36, showing the cavity 44, lip 46, rear portion 47, and, most importantly, the recess 38 which enables access to the disc slot or tray of the display unit (not shown).

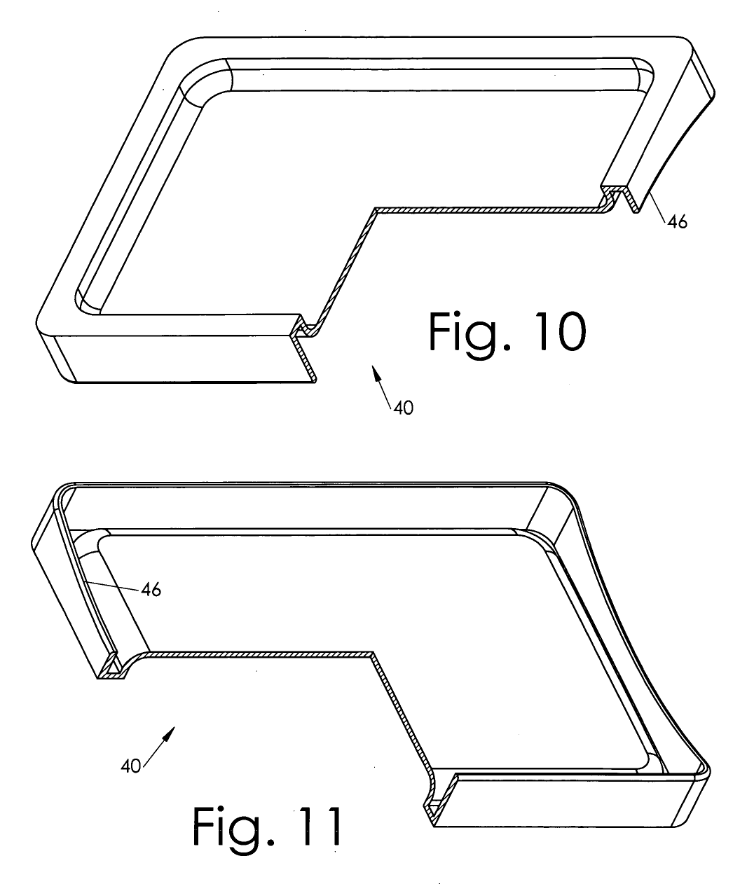

FIGS. 10 and 11 illustrate one embodiment of the adaptor 40, showing the contours of the headrest-specific portion 46.

### CONCLUSION

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

While the shroud and the adaptor have been discussed as two distinct components, in some embodiments they may be of monolithic construction, or the adaptor may be omitted entirely.

Both shroud slots and indented recesses for providing access to the disc slot or disc tray of the video unit may be termed “access openings”.

While the invention has been discussed in terms of optical disc players, it may be used in conjunction with a variety of other removable media formats, such as removable magnetic recording discs such as Zip drives, or with removable solid state media such as flash memory cards, SD secure digital chips, memory sticks, USB thumb drives, and so forth.

While the invention has been discussed in terms of video discs such as DVDs, it may be used in conjunction with a variety of other media types such as BluRay discs, HD video discs, music CDs, SACDs, DVD-As, video game discs or cartridges, and so forth.

While the invention has been shown with the means for receiving (slot or tray) recording media extending from a side or from the top of the video unit, the means for receiving could alternately extend from the bottom or from the front of the video unit.

Various details have been omitted, which are within the ordinary skill of manufacturers and custom installers, for example, the routing of the various power and/or video cables out of the display/shroud/adaptor assembly, into and through the headrest and seat.

While the invention has been described with reference to an automobile seat, it can be used with a variety of other types of vehicle seats such as airplane seats, train seats, boat seats, bus seats, and the like.

What is claimed is:

1. An apparatus for use with an automobile seat, the apparatus comprising:
a video unit including,
a display device,
a media player coupled to the video display device to drive the video display device, and
means for receiving recording media into the media player;
a shroud housing the video unit and including, means for providing access to the means for receiving recording media; and
an adaptor coupled to the shroud for mounting the apparatus to the automobile seat.

2. The apparatus of claim 1 wherein:
the means for receiving comprises a slot.

3. The apparatus of claim 2 wherein:
the means for providing access comprises a recess.

4. The apparatus of claim 2 wherein:
the means for providing access comprises a slot.

5. The apparatus of claim 1 wherein:
the means for receiving comprises a tray.

6. The apparatus of claim 1 wherein:
the shroud includes a lip which extends partially in front of a front surface of the video unit.

7. The apparatus of claim 1 wherein:
the shroud is configured to be disposed sufficiently deeply into the automobile seat that the media player is at least partially disposed within the automobile seat but sufficiently shallowly that the means for receiving remains accessible to a user.

8. An apparatus comprising:
a vehicle seat;
a video unit including,
a display device, and
a media player coupled to provide a video signal to the display device,
the media player including one of a slot and a tray for receiving recording media; and
a shroud coupled to the vehicle seat and including,
a cavity housing the video unit and exposing the display device for viewing, and
an access opening aligned with and providing access to the one of a slot and a tray.

9. The apparatus of claim 8 further comprising:
an adaptor coupling the shroud to the vehicle seat.

10. The apparatus of claim 8 wherein:
the one of a slot and a tray extends out a side of the media player; and
the access opening extends through a side of the shroud.

11. The apparatus of claim 8 wherein:
the one of a slot and a tray extends out a top of the media player; and
the access opening extends through a top of the shroud.

12. The apparatus of claim 8 wherein:
the display device and the media player together comprise one integral component.

13. The apparatus of claim 8 wherein:
the display device and the media player are separate components.

14. The apparatus of claim 13 wherein:
the display device and the media player are coupled together.

15. The apparatus of claim 8 wherein:
the shroud is disposed at least partially within the headrest.

16. The apparatus of claim 15 wherein:
the shroud is disposed at least partially within the headrest sufficiently far that at least a portion of the video unit is disposed within the headrest.

17. The apparatus of claim 16 wherein:
the one of a slot and a tray remains accessible from without the headrest.

18. An apparatus for coupling a video display and disc player assembly to a vehicle seat back or headrest, the apparatus comprising:
an adaptor which is custom fit to the vehicle seat back or headrest; and
a shroud which is configured to mate with the adaptor and which includes,
a cavity for holding the video display and disc player assembly,
a lip extending inwardly to retain the video display and disc player assembly in the cavity, and
an opening extending into the cavity and configured to permit insertion and removal of video discs into and out from one of a slot and a tray of the disc player.

19. The apparatus of claim 18 wherein the opening comprises a slot.

20. The apparatus of claim 18 wherein the opening comprises a recess.
